(19) United States
(12) Patent Application Publication
(10) Pub. No.: US 2006/0086660 A1
(43) Pub. Date: Apr. 27, 2006

(54) Integrated technology for treatment and valorization of organic waste

(75) Inventors: Dennis Glen Hodgkinson, Winnipeg (CA); Richard Royer, Sherbrooke (CA); Gerard Laganiere, Fleurimont (CA)

Correspondence Address: WOOD, PHILLIPS, KATZ, CLARK & MORTIMER, 500 W. MADISON STREET, SUITE 3800, CHICAGO, IL, 60661, US

(73) Assignee: Bio-Terre Systems Inc.

(21) Appl. No.: 11/252,689

(22) Filed: Oct. 18, 2005

Related U.S. Application Data
(63) Continuation-in-part of application No. 10/622,564, filed on Jul. 18, 2003.
(60) Provisional application No. 60/396,749, filed on Jul. 19, 2002.

(51) Int. Cl. C02F 3/28

(52) U.S. Cl. 210/603; 210/609

(57) ABSTRACT

The present invention is related to an integrated process for the treatment and valorization of organic waste, the process comprising the steps of treating the organic waste with a microorganism treatment for producing gas; separating the organic waste resulting from step a) into a liquid fraction and a solid fraction; and using the liquid fraction resulting from step b) as a fertilizer. The present invention also relates to the use of a liquid fraction obtained from the solid liquid separation of an organic waste previously treated by a microorganism treatment as a fertilizer.

### CROSS REFERENCE TO RELATED APPLICATIONS

This application is a continuation-in-part application of application Ser. No. 10/622,564 filed Jul. 18, 2003, which claims the priority of provisional application Ser. No. 60/396,749 filed Jul. 19, 2002.

### BACKGROUND OF THE INVENTION

(a) Field of the Invention

This invention relates to an integrated technology for the treatment and the valorization of organic waste.

(b) Description of Prior Art

Swine production is an important industry in many countries for which many environmental concerns are taking an increased importance. The water contamination being associated with spreading swine manure on the land have been in the past the cause of many tragedies in the rural regions.

Moreover, the populations living around porcine production are complaining about odors that are greatly affecting their quality of life when it is not their health that is affected.

Pigs producers and other animal producers are using different types of barns and buildings to grow their animals. Some producers cover all stages of production and others are finishers only (from 20 kg to 110 kg). These animals produce manure that is managed as solid or liquid depending on the producer's operations and installations.

Liquid management of the manure is the most popular. It needs less manpower and is most cost effective. However, the quantities of manure to manage are enormous (from 0.35 to 1.0 m³ per pig produced) and generate odors, contain pathogens, phosphorous and other substances contaminating the environment and being of potential danger for public health.

U.S. Pat. No. 5,863,434 discloses a process for treating animal manure with microorganisms in an anaerobic environment. Biogas is then produced by the microorganisms. However, this patent is not providing an integrated solution with a valorization of the biogas produced.

It would be highly desirable to be provided with a process that allows to treat animal manure, to use the valuable nutrient as agriculture fertilizer, to generate energy useful on the farm and to properly dispose or valorize the undesirable inorganic waste.

### SUMMARY OF THE INVENTION

One object of the present invention is to provide a technology that valorizes the undesirable portion of the organic waste.

A second object of the present invention is to provide a technology for the treatment of organic waste that allows the use of the treated organic waste as a fertilizer.

A third object of the present invention is to provide a technology that generates energy useful on a farm site.

In accordance with the present invention, there is provided an integrated process for the treatment and valorization of organic waste, the process comprising the steps of:

a) treating the organic waste with a microorganism treatment for producing gas;

b) separating the organic waste resulting from step a) into a liquid fraction and a solid fraction; and

c) using the liquid fraction resulting from step b) as a fertilizer wherein the process is carried out at atmospheric pressure.

The process in accordance with a preferred embodiment of the present invention, wherein said microorganism is a bacterium.

The process in accordance with a preferred embodiment of the present invention, wherein the microorganism treatment is an anaerobic bacterial treatment.

The process in accordance with a preferred embodiment of the present invention, wherein the organic waste is animal manure, more preferably swine manure.

The process in accordance with a preferred embodiment of the present invention, further comprising a step of drying the solid fraction resulting from step b) between step b) and step c) or after step c).

The process in accordance with a preferred embodiment of the present invention, further comprising a step of burning the solid fraction resulting from step b) between step b) and step c) or after step c).

The process in accordance with a preferred embodiment of the present invention, further comprising a step of using the gas resulting from step a) as an energy source. This energy source can preferably be used for electricity generation and/or heat generation. More preferably, the gas is purified before its use as an energy source. This purification results in the reduction of the quantity of hydrogen sulfide from the gas. This reduction varies between 60% and 85%, more preferably 85%, of hydrogen sulfide producing during a digestion cycle depending on peak concentration.

The process in accordance with a preferred embodiment of the present invention, wherein the solid fraction resulting from step b) is used as an energy source as well.

In accordance with the present invention, there is further provided the use of a liquid fraction obtained from the solid liquid separation of an organic waste previously treated by a microorganism treatment as a fertilizer. This microorganism treatment is preferably a bacterial treatment, more preferably an anaerobic bacterial treatment.

For the purpose of the present invention the following terms are defined below.

The term “biogas” is intended to mean gas obtained from the destruction of organic matter.

The term “organic waste” is intended to mean, without limitations, matter as animal feces, urine, milkhouse wastewater, litter and deadstocks.

The term “bacterial treatment” is intended to mean a process where microorganisms are digesting organic waste and are producing biogas.

The term “valorization” is intended to mean the usage of the by products of a technology such as biogas, digested manure, inorganic residues, to as a raw material for transformation into energy and or value added product.

All references herein are incorporated by reference.

### BRIEF DESCRIPTION OF THE DRAWINGS

FIG. 1 is a schema of the treatment and valorization system of a preferred embodiment of the present invention;

FIG. 2 is a block diagram of the biogas process of the embodiment of FIG. 1;

FIG. 3 is a block diagram of the power generation unit of the embodiment of FIG. 1;

FIG. 4 is a block diagram of the liquid process of the embodiment of FIG. 1; and

FIG. 5 is a block diagram of the dewatering system of the embodiment of FIG. 1.

### DETAILED DESCRIPTION OF THE INVENTION

In accordance with the present invention, there is provided an integrated technology for the treatment and the valorization of organic waste.

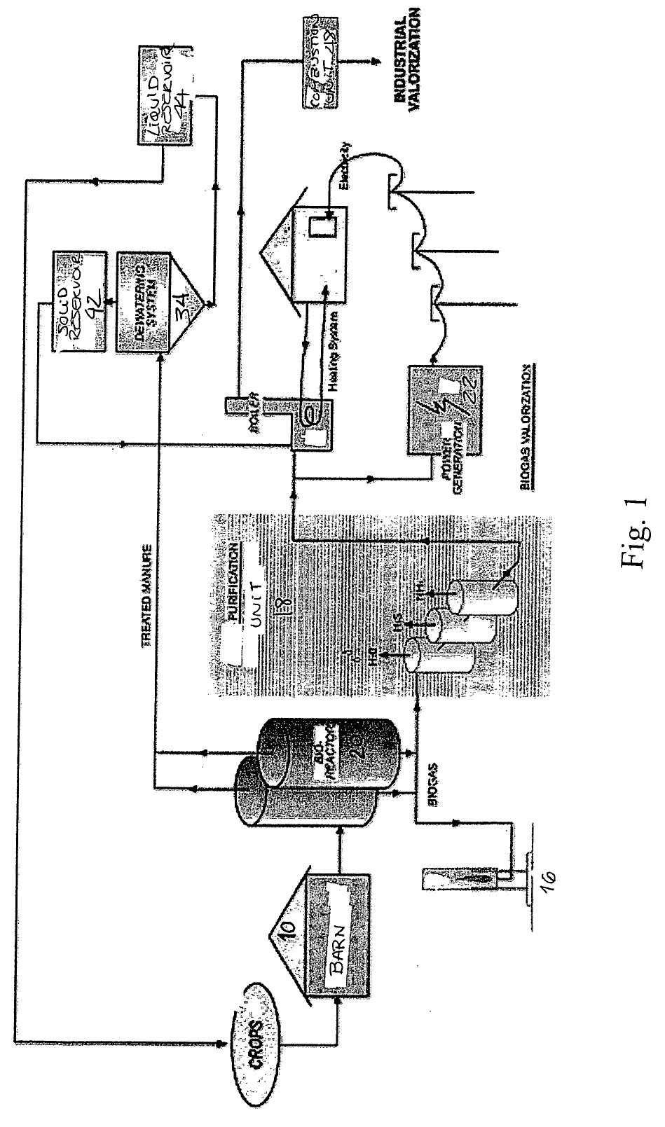

FIG. 1 illustrates the process used for the valorization of animal manure. Animal manure is collected from the barn (10) and is transferred periodically to bioreactors (12) to match the operation of the farm. The manure feeding system can either function by gravity or by pump and the manure can be fed to one bioreactor or to a plurality of bioreactors (12) in concordance with the type and volume of manure and the size of the bioreactors. Raw manure is fed to the bioreactors and its composition depends on the mix volume of many types of manure (sow, piglet or hogs) to obtain a COD (chemical oxygen demand) content that is chosen for the design of the bioreactors. The COD value depends on the temperature and the volume of the bioreactors. Determination of COD value is well known in the art as, for example, in U.S. Pat. No. 5,863,434. Preferred COD values in the present invention are 70-120 kg/m³. The animal manure in the bioreactors (12) is treated by microorganisms. In a preferred embodiment of the present invention, the animal manure is treated in accordance with the technology of anaerobic digestion under low temperature as described in the U.S. Pat. No. 5,863,434. The residence time of the manure in the bioreactors (12) is a period of time sufficient for a full production cycle of biogas by the microorganism. In a preferred embodiment of the present invention, this period of time is sufficient for the microorganism to digest 80% of the organic matter and the biogas produced has an average of 70% of CH₄. This period of time also allows reduction of COD, elimination of manure pathogens and elimination of the odors related to manure composition. In a more preferred embodiment of the present invention, the residence time is between 7-21 days.

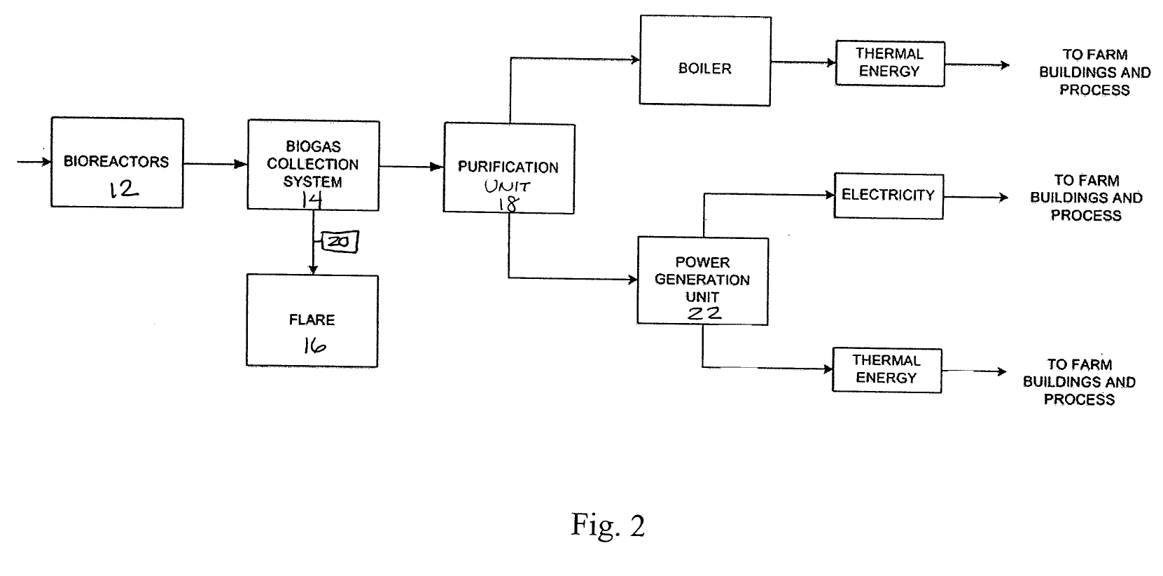

As illustrated in more details in FIG. 2, the biogas produced during the manure treatment is captured by a gas collection system (14), which can be one of pump, compressor, blower or any other mechanism known to the one skilled in the art as being suitable for collecting gas. The biogas collected is sent to a flare (16) or is sent to a purification unit (18). The flare (16) is used to burn the excess volume of gas that cannot be processed and during emergency or plant shut down for maintenance. For security reasons, a flame arrester (20) is preferably located in the gas entrance to prevent the flames from the flare (16) from going back to the bioreactors (12).

The biogas produced is sent to the purification unit (18) to eliminate the hydrogen sulfide and some of the water vapor present in the biogas. The hydrogen sulfide (H₂S) concentration varies in time and is related to methane production. The methane and H₂S production are related since the methanogens and the sulfate reducer bacteria both use acetic and propionic acid as a substrate to produce methane and H₂S. Tests done on the semi-industrial scale bioreactors has shown that the H₂S concentration varies between 1000 and 6000 ppm during a cycle of anaerobic digestion and H₂S concentration follows the same profile as biogas production curve.

In a preferred embodiment of the present invention, the purification unit (18) consists in a combination of more than one filtration units. It is designed to cut off the peaks of H₂S concentration and maintain an acceptable H₂S level at the exit of the process. The filters preferably used are commercially available filters such as Sulfatreat™ 410HP (The Sulfatreat Company, Chesterfield, Mo., USA), which uses a fixed bed with iron oxide type media.

The lab results has shown that under stable H₂S concentration of 3000 ppm, the filtration efficiency remain at 83% after 7 days of operation and the efficiency of this treatment is enhanced when the biogas is saturated with water.

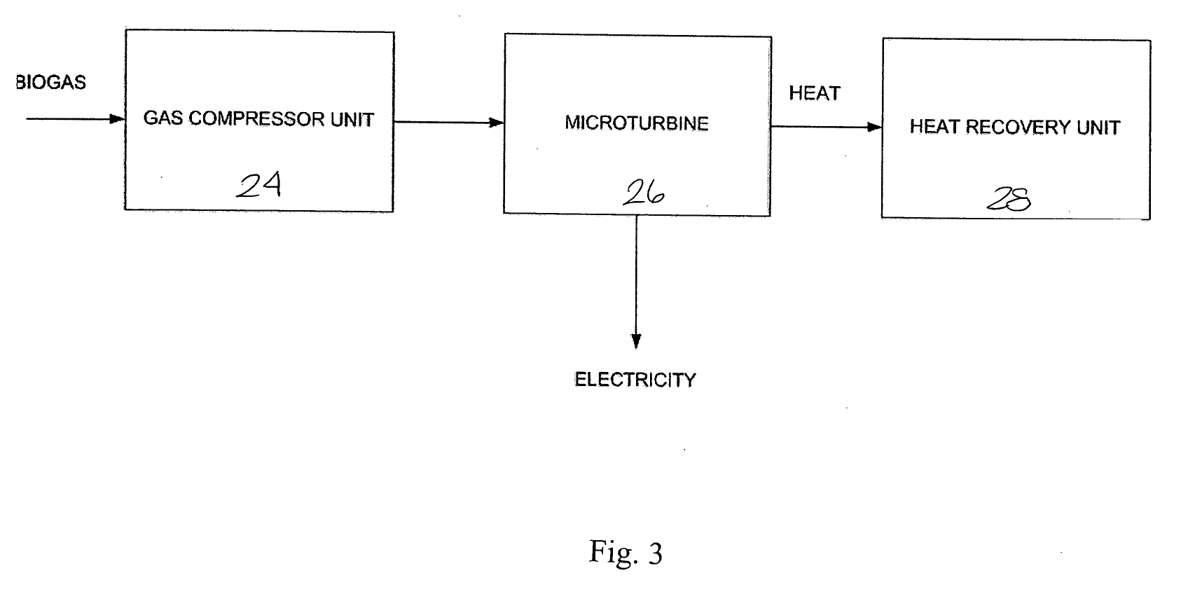

The treated biogas is send to a power generation unit (22) for electricity generation. FIG. 3 illustrates the power generation unit (22). The biogas is introduced in a gas compressor (24) which is designed to secure a constant intake of biogas at an electricity generation device, which is a microturbine (26) (Capstone Turbine Corporation). The person skilled in the art will however understand that any device capable of generating electricity from a gas, such as driving motors, piston or turbine, would be suitable for the purpose of the present invention. The gas compressor (24) takes the biogas and compresses it until it reaches a suitable pressure in accordance with the standard equipment. In a preferred embodiment of the present invention, such a pressure is of the range of 60-100 psig using the microturbine (26). After having been compressed, the biogas is fed to the microturbine (26). Electricity is generated from the microturbine (26) and a heat recovery unit (28) is preferably added to recover at least a portion of the heat generated by the microturbine (26). Many different equipment would be suitable to reach that goal and would be known by the man skilled in the art, but a preferred equipment is a 60/30 Heat PlusPower™ Systems from Mariah Energy Corp. where hot water produced can be used to heat farm buildings, the bioreactors (12) or used in the process.

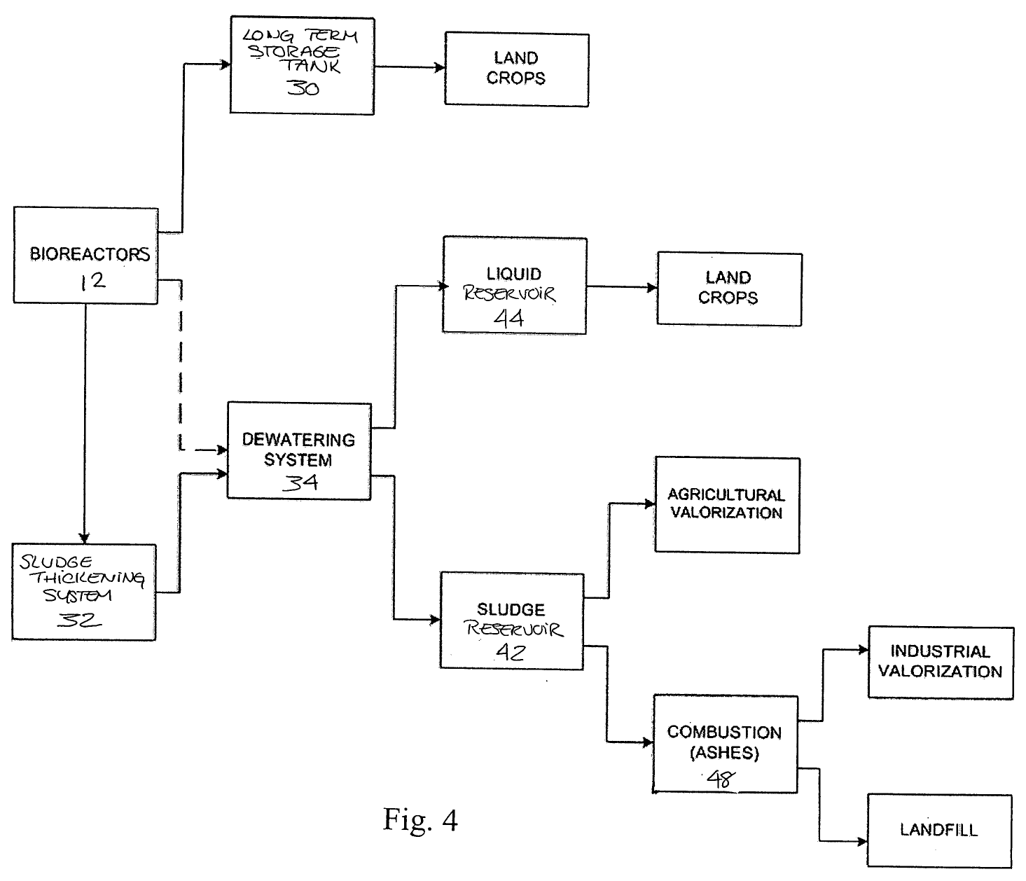

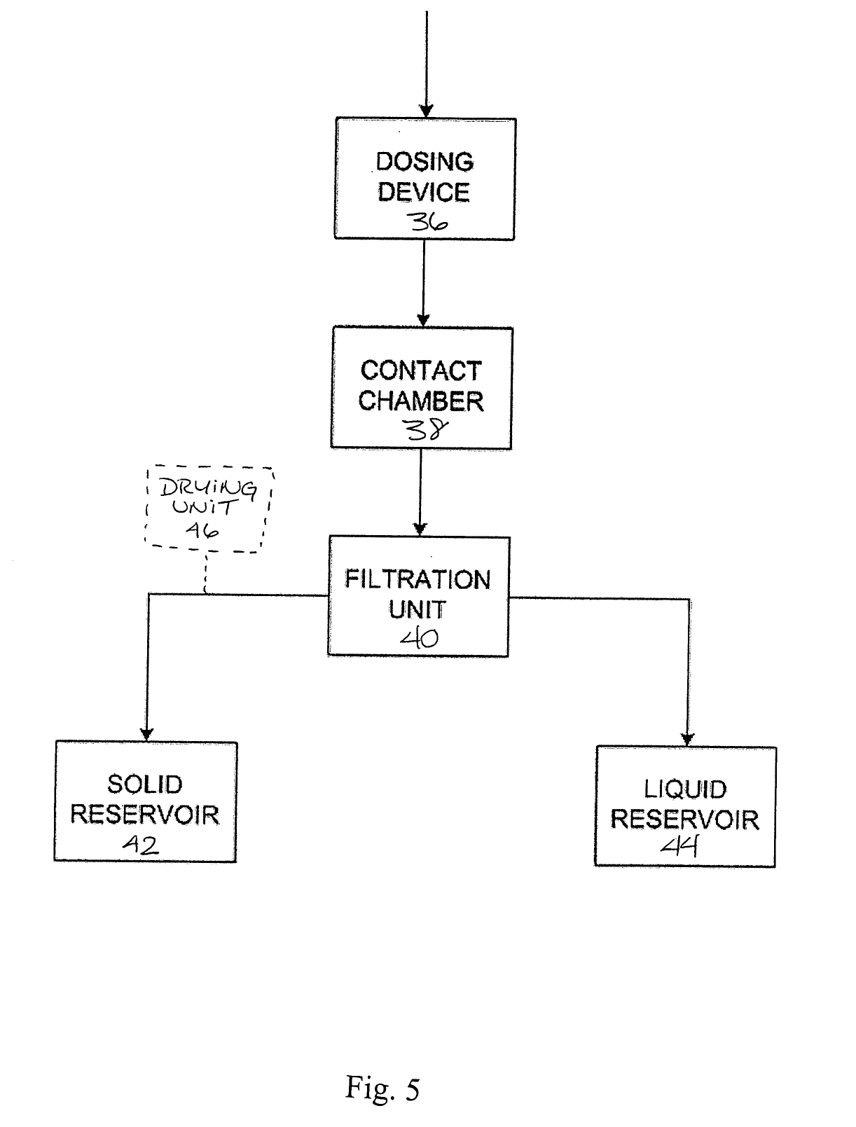

As illustrated in FIG. 4, the treated manure can either be transferred to a long term storage tank (30) or transferred from the bioreactors (12) to a sludge thickening system (32) in order to remove phosphorus content by passing through a dewatering system (34). The dewatering system (34) is better illustrated at FIG. 5 and includes a dosing device (36) for mixing the manure and additives used to enhance coagulation and flocculation before transferring in a contact chamber (38). The input flow of the additives is calculated based on the input flow of the treated manure. The dewatering system (34) further comprises a filtration unit (40) for receiving the manure containing the flocculation products from the contact chamber (38). The separation provided in the filtration unit (40) is a combination of filtration and decantation using filtering media. The solid portion is kept at the surface of the media to be later transferred in a solid reservoir (42) and the liquid is collected at the exit of the filtration unit (40) and transferred to a liquid reservoir (44) or to the long term storage tank (30). A drying unit (46) can optionally follow the filtering unit (40) in order to drying the solid portion resulting from the separation. The liquid fraction obtained through the dewatering system (80) represents 80-90% of the initial volume of the treated manure and it contains all nutrients needed by the crops such as nitrogen, potassium and has a lower phosphorous content equivalent to 15-20% of the original concentration. The solid fraction remaining after the solid liquid separation represents 10-20% of the initial volume treated. It contains 75-80% of the phosphorous and small amount of nitrogen and potassium. The solid fraction has an average of 87% of humidity which can be lower if the filtration unit (40) is combined with the drying unit (46). The solid fraction is composed of 60% of organic matter, principally carbon, oxygen, small percentage of hydrogen and nitrogen. After the separation, the solid fraction can either be sent without further treatment to agricultural valorization and used as a high phosphorous content fertilizer or it can be sent to a combustion unit (48) to be burned. The dry solid fraction has an average calorific value of 15.33 kJ/g. The remaining ashes only comprising minerals are found to have a significant smaller volume than the original solid fraction. The volume reduction is more than 90% of the initial volume of solid fraction. The minerals found in the ashes are mainly calcium, aluminum, phosphate, manganese and iron. The ashes are easier to handle, dispose and are safe for the environment. They can be used for industrial valorization of safely disposed in landfill site. The energy developed by the burning of the solid fraction can be optionally captured and reused in the process.

Alternatively, the treated manure can be transferred directly from the bioreactors (12) to the long term storage tank (30). At this point, the treated manure is nearly odorless, has a lower by an average of 50% solid content because of the destruction of the volatile solids during the anaerobic digestion. The treated manure coming from the bioreactors (12) has a stable nutrients content. The nitrogen and the potassium content is almost 80-90% of the initial content of the raw manure but the nitrogen is present in a form that is far easier to assimilate by the crops than the nitrogen in raw manure, thereby reducing nitrous oxide emission (N₂O), which is a very harmful green house gas. The phosphorous content of the liquid fraction of the treated manure is approximately 30% of the original content in the raw manure. The treated manure produces an excellent liquid fertilizer since the phosphorous content is low and the nitrogen and the potassium content is high. This fertilizer provides a good balance of N-P-K ratio for the spreading and allows a customized balance of nitrogen and phosphorous to match the crops demand.

The bioreactors of the present invention are used at atmospheric pressure and ambient temperature. The bioreactors are built and contain a PVC membrane 40 mil (a bag) in which there are manure and biogas. The bioreactors are exposed to the open air since the biogas is released naturally through a chimney installed at the top of the bioreactors.

In a further embodiment, a biogas pump is installed in order to displace the biogas from the bioreactor to energy valorization equipment. This pump does not maintain any pressure in the system. Even when the pump is inactive, the anaerobic digestion system continues to work without any problem, the biogas continues to flow towards the torch.

In a further embodiment, a floating roof is installed in one of the bioreactors. It is made of two PVC membranes soldered together, in which air has been insufflated. The floating roof is only laid down on the top of the manure. Its shape allows biogas collection directly on top of the liquid.

The bioreactors cannot accumulate pressure since there will be rising of the floating roof and biogas evacuation through the aeration opening located on top of the silo.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

What is claimed is:

1. An integrated process for the treatment and valorization of organic waste, said process comprising the steps of:
a) treating said organic waste with a microorganism treatment for producing gas;
b) separating the organic waste resulting from step a) into a liquid fraction and a solid fraction; and
c) using the liquid fraction resulting from step b) as a fertilizer wherein the process is carried out at atmospheric pressure.

2. The process of claim 1, wherein said microorganism is a bacterium.

3. The process of claim 1, wherein said microorganism treatment is an anaerobic bacterial treatment.

4. The process of claim 1, wherein said organic waste is animal manure.

5. The process of claim 1, wherein said animal manure is swine manure.

6. The process of claim 1, further comprising a step of drying the solid fraction resulting from step b) between step b) and step c) or after step c).

7. The process of claim 1, further comprising a step of burning the solid fraction resulting from step b) between step b) and step c) or after step c).

8. The process of claim 1, further comprising a step of using said gas resulting from step a) as an energy source.

9. The process of claim 9, wherein said energy source is for at least one of electricity generation and heat generation.

10. The process of claim 8, further comprising a step of purifying said gas resulting from step a) before the step of using said gas as an energy source.

11. The process of claim 10, wherein said step of purifying consist in the reduction of hydrogen sulfide content from said gas.

12. The process of claim 11, wherein said reduction varies between 60% and 85% for a full digestion cycle.

13. The process of claim 11, wherein said reduction is of about 85% for a full digestion cycle.

14. The process of claim 1, wherein said solid fraction resulting from step b) is used as an energy source.

15. The process of claim 14, wherein said energy source is for at least one of electricity generation and heat generation.
